(19) United States
(12) Patent Application Publication
(10) Pub. No.: US 2016/0101995 A1
(43) Pub. Date: Apr. 14, 2016

(54) WATER RECOVERY SYSTEM, ASSEMBLY AND METHOD FOR USE OF RETENTATE RECOVERED FROM MEMBRANE-BASED FILTRATION DEVICES

(71) Applicant: Staubach Barror Water Systems, Inc., Schenectady, NY (US)

(72) Inventors: Jarrod J. Staubach, Westerlo, NY (US); Christopher R. Barror, Schroon Lake, NY (US); Joseph Sala, Cooperstown, NY (US)

(73) Assignee: Staubach Barror Water Systems, Inc., Schenectady, NY (US)

(21) Appl. No.: 14/865,808

(22) Filed: Sep. 25, 2015

Related U.S. Application Data
(60) Provisional application No. 62/055,693, filed on Sep. 26, 2014.

(51) Int. Cl. C02F 1/44; C02F 1/42

(52) U.S. Cl. CPC C02F 1/441; C02F 1/42; C02F 2201/005; C02F 2209/42

(57) ABSTRACT

A water recovery system, in an embodiment, has at least one container fluidly connectable to a membrane-based filtration device. The water recovery system collects retentate or reject water from the membrane-based filtration device. In operation, the water recover system supplies the collected retentate or reject water to other apparatuses that have functions other than membrane-based water filtration.

### CROSS-REFERENCE TO RELATED APPLICATION

This application is a non-provisional of, and claims the benefit and priority of, U.S. Provisional Patent Application No. 62/055,693, filed on Sep. 26, 2014. The entire contents of such application are hereby incorporated by reference.

### BACKGROUND

Water can contain undesirable solids, chemicals and other contaminants. Processes are used to purify water to a relatively high level of purity for sensitive applications. For example, a relatively high level of purity is required for the operation of medical dialysis machines and for the manufacturing of pharmaceutical products.

Water purification processes typically involve the initial step of pretreatment. The pretreatment involves the use of screen filters to remove relatively large solids suspended in the water. The pretreatment can also involve chemical treatment.

After the pretreatment, membrane-based filtering can be used to achieve a higher level of purity. This type of filtering relies upon semi-permeable membranes. There can be a relatively high amount of water waste in membrane-based filtering. For example, in reverse osmosis (RO) filtration processes, 50% to 90% of the feed water can be rejected and sent to the drain. This loss in water can create a negative impact on the environment and on the availability of water resources for communities. Furthermore, the loss in water can present significant costs to facility operators. In the case of healthcare, for example, the water costs can burden healthcare providers which, in turn, can result in higher costs to patients.

The foregoing background describes some, but not necessarily all, of the problems, disadvantages and shortcomings related to membrane-based water filtering, including, but not limited to, reverse osmosis filtering.

### SUMMARY

The water recovery system, in an embodiment, includes: (a) at least one container; (b) at least one inflow port fluidly connected to the at least one container, wherein the at least one inflow port is configured to receive retentate or reject water from a retentate line of a membrane-based filtration device; (c) at least one outflow port configured to fluidly connect the at least one container to an apparatus other than the membrane-based filtration device, wherein the apparatus has a function other than membrane-based water filtration; and (d) at least one pump operable to move the retentate from the at least one container, through the outflow port, to the apparatus. The apparatus is operable with the retentate to perform such function.

In another embodiment, the subject matter disclosed herein includes a method for utilizing retentate from a membrane-based filtration device. The method includes: (a) providing at least one container having at least one inflow port and at least one outflow port; (b) fluidly connecting the at least one inflow port to a retentate conduit of a membrane-based filtration device; (c) as a result of an operation of the membrane-based filtration device, collecting retentate from the membrane-based filtration device, wherein the retentate flows through the retentate conduit, through the at least one inflow port and into the at least one container; and (d) pumping retentate from the at least one container, through the at least one outflow port and to an apparatus other than the membrane-based filtration device. The apparatus has such function other than reverse osmosis filtration, and the apparatus is operable with the retentate to perform such function.

In an embodiment, the water recovery system includes: (a) at least one container or tank; (b) at least one inflow port fluidly connected to the container or tank, wherein the inflow port is configured to be fluidly connected to a reject water conduit of a reverse osmosis device operable in accordance with a reverse osmosis filtration process, and wherein the reverse osmosis device is configured to output: (i) permeate or product water through a product water conduit of the reverse osmosis device; and (ii) retentate or reject water through the reject water conduit; (c) at least one pump; (d) at least one outflow port fluidly connected to the at least one tank, wherein the at least one outflow port is configured to fluidly connect the tank to an apparatus other than the reverse osmosis device; and (e) at least one controller operable to control the pump to move the retentate or reject water from the container or tank, through the at least one outflow port, to the apparatus. The apparatus is operable with the retentate or reject water, and the water recovery system facilitates usefulness of the retentate or reject water for one or more processes of the apparatus other than the reverse osmosis filtration process.

Additional features and advantages of the present disclosure are described in, and will be apparent from, the following Brief Description of the Drawings and Detailed Description.

### BRIEF DESCRIPTION OF THE DRAWINGS

FIG. 1 is schematic diagram of an embodiment of the water recovery system, illustrating its operation with a membrane-based filtration device and one or more apparatuses other than the membrane-based filtration device.

FIG. 2 is schematic diagram of an embodiment of the water recovery system, illustrating its operation with an RO device, pretreatment tanks and a medical waste processing apparatus.

FIG. 3 is a fragmentary view of the water recovery system of FIG. 2, providing an enlarged view of the water recovery tank.

FIG. 4 is a schematic diagram of another embodiment of the water recovery system, illustrating its operation with an RO device, pretreatment tanks and a medical waste processing apparatus.

FIG. 5 is a schematic diagram of yet another embodiment of the water recovery system, illustrating the water recovery tank and other components of the water recovery system.

FIG. 6 is a top, isometric view of the water recovery system of FIG. 5, illustrating the water recovery tank and the water tank support structure.

### DETAILED DESCRIPTION

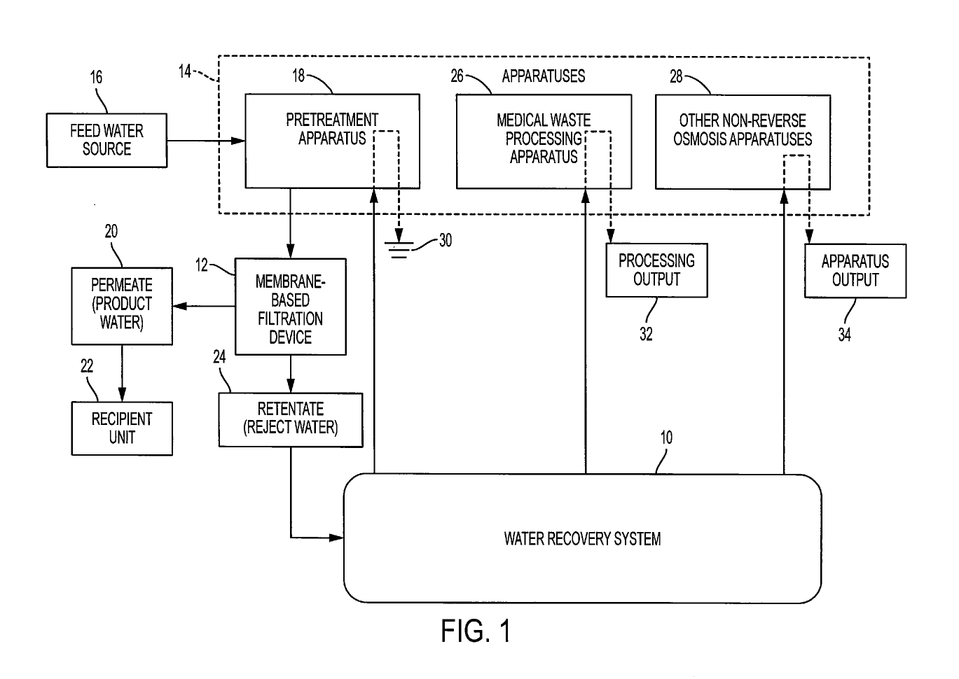

Referring to FIG. 1, in an embodiment, the water recovery system 10 is usable in conjunction with a membrane-based filtration device 12 and one or more apparatuses 14. The water recovery system 10 is operable to recover retentate or reject water from the membrane-based filtration device 12. After recovery, the water recovery system 10 enables the reject water to be recycled, reused or otherwise used for functions other than membrane-based filtration. This avoids the waste or loss of the reject water to drains.

The membrane-based filtration device 12 can be any suitable water filtration device that filters or purifies water based on one or more semi-permeable membranes. The membranes can be constructed of any suitable material such as a suitable polymer configured with suitably sized pores or a porous structure.

It should be appreciated that the membrane-based filtration device 12 can be based on different types of membrane-based filtering. In an embodiment, there are different categories of membranes for different types of membrane-based filtration. In order of increasing purification, these types include, but are not limited to, the following: microfiltration (capable of removing particles of 500 angstroms or larger), ultrafiltration (capable of removing particles of 30 angstroms or larger), nanofiltration (capable of removing particles of 10 angstroms or larger) and reverse osmosis (RO) (capable of removing particles of 5 angstroms or larger). In an embodiment, the membrane-based filtration device 12 is a reverse osmosis filtration device having one or more filters including reverse osmosis membranes.

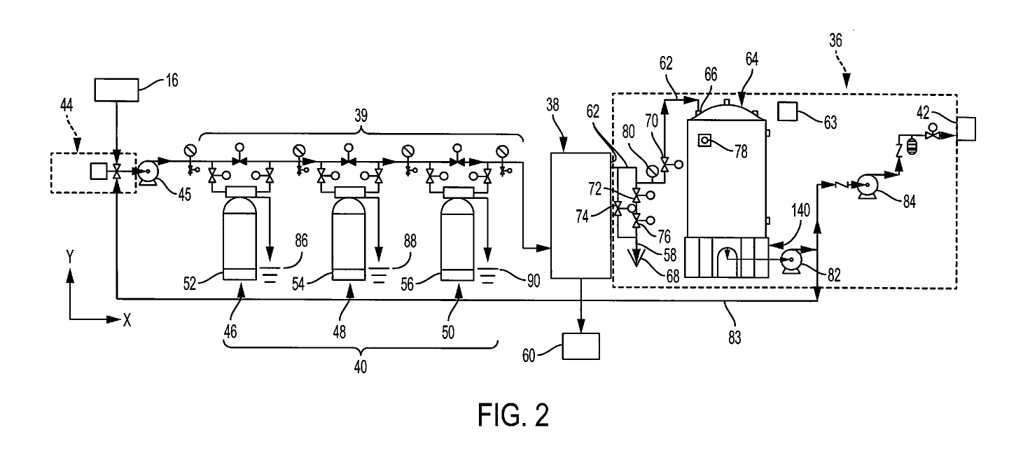

In operation, a feed water source 16 directs feed water, such as tap water, to a water pretreatment apparatus or pretreatment apparatus 18. In an embodiment described below, the pretreatment apparatus 18 includes one or more pretreatment tanks 40 (FIG. 2). The pretreatment apparatus 18 functions to treat the feed water before the feed water flows to the membrane-based filtration device 12. Accordingly, the pretreatment apparatus 18 can function to chemically pretreat the feed water. Also, the pretreatment apparatus 18 can function to remove relatively large undissolved particles that could be damaging to the delicate membranes of the membrane-based filtration device 12.

In an embodiment, the processing and filtration functions of the pretreatment apparatus 18 exclude any physical interaction between the incoming feed water and any filtration membranes, including, but not limited, to a reverse osmosis membrane. Accordingly, the pretreatment apparatus 18 has one or more non-membrane filtration functions or non-RO filtration functions.

The pretreated feed water then flows to the membrane-based filtration device 12. In the reverse osmosis process, the pretreated feed water is pressurized on one side of a semi-permeable reverse osmosis membrane. The pressure is high enough to exceed the osmotic pressure to cause a reverse osmotic flow of water. The reverse osmosis membrane blocks solutes and undissolved particles, and enables purified water to pass through the reverse osmosis membrane. The water passing through the reverse osmosis membrane may be referred to as permeate or product water 20. The product water 20, having been purified by the membrane-based filtration device 12, is directed to the recipient unit 22. Depending upon the embodiment, the recipient unit 22 can be a purified water supply line, a purified water reservoir, a machine such as a medical dialysis machine or other medical treatment equipment, or a patient.

In a phase of generating the product water 20, only a portion of the pretreated feed water processes into product water 20. The other portion of the pretreated feed water is not usable in that phase to generate product water 20. This is because there is a point at which the applied pressure is no longer great enough to overcome the osmotic pressure. Consequently, there is no further migration through the reverse osmosis membrane. Furthermore, if the applied pressure were increased in an attempt to gain more product water 20, undissolved particles can damage the reverse osmosis membranes. Therefore, the membrane-based filtration device 12 has a controller that regulates the incoming pretreated feed water. Under this regulation, the membrane-based filtration device 12 causes a significant percentage of the pretreated feed water to exit without receiving membrane-based filtration. This exiting, pretreated feed water may be referred to as retentate or reject water 24. The retentate or reject water 24 includes feed water that has physically contacted a membrane but has not passed through such membrane. When an RO device is used, such as RO device 38 (FIG. 2), the retentate or reject water 24 includes feed water that has physically contacted an RO membrane but has not passed through such RO membrane.

To avoid the drainage and wasting of the reject water 24, the water recovery system 10 receives the reject water 24 from the membrane-based filtration device 12. The water recovery system 10 stores the reject water 24 for future delivery to different types of apparatuses 14. For example, the water recovery system 10 can operate to flush the pretreatment apparatus 18, to supply water to the medical waste processing apparatus 26, or to supply water to other apparatuses 28 other than the membrane-based filtration device 12, such as other non-RO apparatuses. Depending upon the embodiment, the water recovery system 10 can supply reject water 24 to the different apparatuses 14 at different times or simultaneously. Furthermore, depending upon the embodiment, the water recovery system 10 can supply reject water 24 to the apparatuses 14 during operation of the membrane-based filtration device 12 or when the membrane-based filtration device 12 is powered-off.

The pretreatment apparatus 18, as described above, can collect undissolved particles and chemicals. For proper operation, the pretreatment apparatus 18 should be cleaned or flushed periodically. When the water recovery system 10 is used in a flush mode, the water recovery system 10 pumps reject water 24 from the water recovery system 10 to the pretreatment apparatus 18. The reject water 24 circulates through the pretreatment apparatus 18 to gather undissolved particles and chemicals. Carrying the undissolved particles and chemicals, the circulated water is directed to the drain 30. The water recovery system 10 increases the pressure of the reject water to a level that is suitable or otherwise necessary for flushing of the pretreatment apparatus 18.

The medical waste processing apparatus 26 functions to manage medical waste, including, but not limited to, used syringes, used catheters and other used medical disposables. Depending upon the embodiment, the medical waste processing apparatus 26 can disinfect medical waste, disintegrate medical waste, recycle medical waste or otherwise transform medical waste into a different form or shape, including, but not limited, to paste, liquid, pellets or powder. The medical waste processing apparatus 26 requires a source of water for operation. When the water recovery system 10 is used in a supply mode, the water recovery system 10 pumps reject water 24 from the water recovery system 10 to the medical waste processing apparatus 26. The medical waste processing apparatus 26 uses the reject water 24 to process the medical waste and generate the processing output 32, such as disinfected paste, liquid, pellets or powder.

In an embodiment, the processing functions of the medical waste processing apparatus 26 exclude any physical interaction between the incoming reject water and any filtration membranes, including, but not limited, to a reverse osmosis membrane. Accordingly, the medical waste processing apparatus 26 has one or more non-membrane filtration functions or non-RO filtration functions.

The other apparatus 28 can, depending upon the embodiment, operate for any suitable function other than membrane-based water filtration and RO-filtration. For example, the other apparatus 28 can be a landscape watering system of a manufacturing plant, hospital or other facility, or the apparatus 28 can be a plumbing water supply system for bathrooms, faucets and toilets in facilities. When the water recovery system 10 is used in a supply mode, the water recovery system 10 pumps reject water 24 from the water recovery system 10 to the other apparatus 28. The other apparatus 28 uses the reject water 24 to perform its function and generate any apparatus output 34.

In an embodiment, the functions of the other apparatus 28 exclude any physical interaction between the incoming reject water and any filtration membranes, including, but not limited, to a reverse osmosis membrane. Accordingly, the other apparatus 28 has one or more non-membrane filtration functions or non-RO filtration functions.

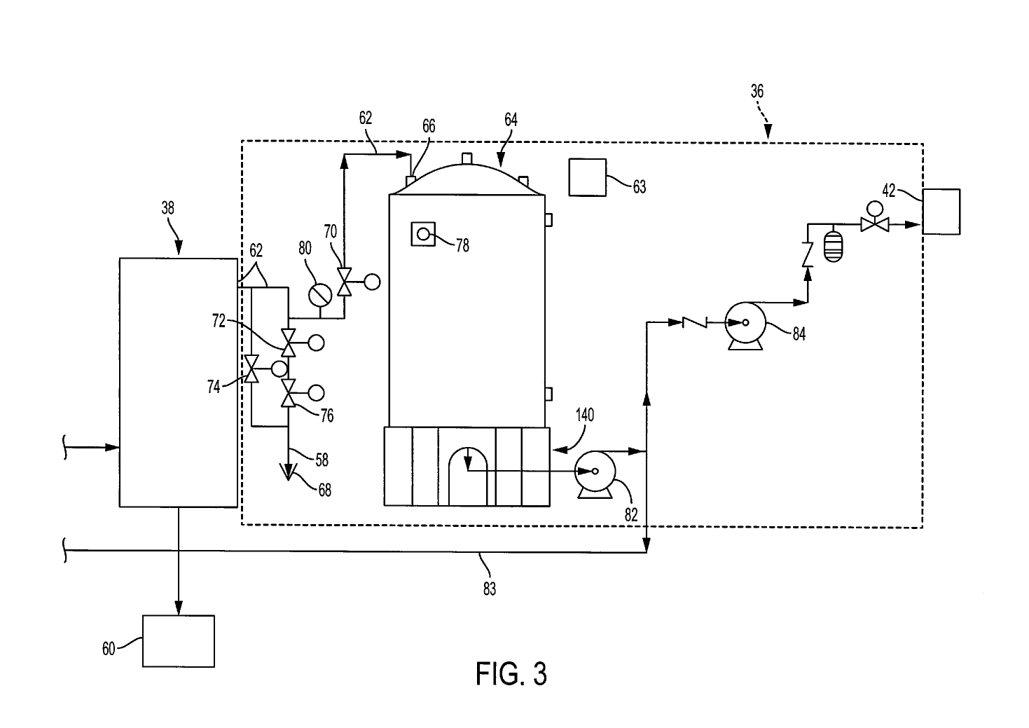

Referring to FIGS. 2-3, in an embodiment: (a) the water recovery system 36 includes and incorporates all of the elements, structure, functionality and logic of water recovery system 10; (b) the RO device 38 includes and incorporates all of the elements, structure, functionality and logic of membrane-based filtration device 12; (c) the pretreatment apparatus 39 includes and incorporates all of the elements, structure, functionality and logic of pretreatment apparatus 18; and (d) the medical waste processing apparatus 42 includes and incorporates all of the elements, structure, functionality and logic of medical waste processing apparatus 26.

In operation, the feed water source 16 directs feed water to the three-way actuated valve 44. When the valve 44 is open, the initial pump 45 pressurizes and pumps the feed water into the pretreatment apparatus 39. In the illustrated embodiment, the pretreatment apparatus 39 includes a plurality of pretreatment tanks 40, such as pretreatment tanks 46, 48 and 50.

In an embodiment, pretreatment tank 46 is a solid screening tank containing a solid screening media 52 operable as a sediment filter. The solid screening media 52 has as a plurality of layers of differently sized rock, sand, coke, coals such as anthracite, iron oxides such as magnetite, or other filtering elements. Pretreatment tank 46 is operable to remove relatively large undissolved particles from the feed water.

Pretreatment tank 48, in an embodiment, is a primary chemical treatment tank containing a carbon media 54, such as a plurality of layers of differently configured active carbon granules, carbon powder or carbon elements. Pretreatment tank 48 is operable to remove contaminants and impurities from the feed water using chemical adsorption. Such contaminates can include chlorine and organic molecules.

In an embodiment, pretreatment tank 50 is a secondary or polishing chemical treatment tank containing a carbon media 56, such as a plurality of layers of differently configured active carbon granules, carbon powder or carbon elements. The carbon media 56 has a smaller granular size than carbon media 54, enabling pretreatment tank 50 to remove smaller-sized contaminants and impurities from the feed water using chemical adsorption.

In the illustrated embodiment, the pretreatment tanks 46, 48 and 50 are fluidly connected in series. As the feed water flows through the pretreatment apparatus 39, the pretreatment tanks 46, 48 and 50 function to filter the feed water, resulting in pretreated feed water. In an embodiment of this filtering process, the pretreatment tanks 46, 48 and 50 do not involve the use of membranes, and the pretreatment tanks 46, 48 and 50 do not involve an RO filtration process.

After pretreatment, the pretreated feed water is supplied to the RO machine or RO device 38. In an embodiment, the RO device 38 has: (a) a permeate or product water conduit or line 58 fluidly connectable to recipient unit 60, such as dialysis machine; and (b) a retentate or reject water conduit or line 62 fluidly connectable to the water recovery system 36.

In operation of the RO device 38, the product water conduit 58 directs permeate or product water to the recipient unit 60. In the case in which the recipient unit 60 is a dialysis machine, the dialysis machine uses the product water to provide a patient with dialysis treatment. Also, in operation of the RO device 38, the reject water conduit 62 directs retentate or reject water to the water recovery system 36.

Referring to FIG. 3, in an embodiment, the water recovery system 36 includes one or more electronic processors, circuit boards or controllers, such as controller 63. The controller 63 is operable to control the functionality of a plurality of components of the water recovery system 36 as described below. The water recovery system 36 also includes a water recovery tank 64 having an inflow port 66 fluidly connected to the reject water line 62 of the RO device 38. The reject water line 62 is in fluid communication with the water recovery tank 64, the RO device 38 and the drain 68, each of which can be accessed by selectively operating valves 70, 72 and 74. A pressure regulator valve 76 acts as a controller that monitors the RO device 38 and drain 68 pressure. In an embodiment, the water recovery tank 64 has a level control valve 78. The level control value 78 cooperates with the pressure regulator valve 76 to direct the flow of reject water to either the water recovery tank 64 or the drain 68 based on a reading from the pressure gauge 80 as well as based on readings from other sensors elsewhere in the water recovery system 36.

The size of the water recovery tank 64 may be selected according to the needs of a particular facility. For example, the water recovery tank 64 can hold between one hundred gallons and one thousand gallons. A one hundred gallon water recovery tank 64, for example, may be used for light duty. In other facilities, where multiple pretreatment tanks 40 are to be flushed and multiple medical waste processing apparatuses 42 are used, a one thousand gallon water recovery tank 64 may be used.

When the RO device 38 is in operation, valve 72 and 74 may be sealed to prevent flow to the drain 68. At such time, valve 70 can be opened such that reject water from the RO device 38 accumulates in the water recovery tank 64. When the RO device 38 is not in operation (e.g. during the night or other maintenance time) reject water is removed from the water recovery tank 64 and pressurized by a system pump 82. The pressure increase occurs before the reject water is used to flush one or more of the pretreatment tanks 40. Under the increased pressure, the reject water flows through the conduit or line 83 to the three-way actuated valve 44, as illustrated in FIG. 2. When the three-way actuated valve 44 is opened for the flush mode, the reject water then flows into the pretreatment apparatus 39 for cleansing and flushing purposes. Benefiting from the paid-for reject water, the operator avoids further cost that would be necessary for purchasing additional tap water for flushing the pretreatment tanks 40. This results in a reduction in costs.

In an embodiment, the system pump 82 is connected in series to a supplemental system pump 84 downstream. The supplemental system pump 84 acts to partially pressurize the reject water for a second, subsequent pressurization step by the supplemental system pump 84. For example, the system pump 82 can increase the reject water pressure to a pressure between thirty PSI and fifty PSI. In the embodiment of FIG. 2, the reject water is returned to the initial pump 45 to be re-pressurized (e.g. to about seventy PSI) for subsequent flushing purposes. In an embodiment, during the flushing of the pretreatment tanks 40, the RO device 38 is electronically disabled and incapable of using any water from any source in accordance with the applicable controls and regulations set forth by the Food and Drug Administration (FDA) and the Association for the Advancement of Medical Instrumentation (AAMI) regulations. In such embodiment, all reject water used to flush the pretreatment tanks 40 is directed to pretreatment drain 86, 88 or 90.

In an embodiment, the level control valve 78, under control of a controller, will close. The closing of valve 78 directs water through the pressure regulator valve 76 to access the drain 68. This prevents further accumulation of reject water in the water recovery tank 64 when the water level in the water recover tank 64 has reached a designated level. The water reject line 62 or level control valve 78 can also be equipped with a pressure sensor connected to the controller 63 to open valve 76 to access the drain 68 if the pressure within the water reject line 62 and/or the water recovery tank 64 exceeds a designated value. In an embodiment, the pressure in the water recovery tank 64 is maintained below about fifteen PSI.

During a flushing operation or flush mode, the water recovery system 36 directs a designated volume of reject water to the pretreatment tanks 40 for cleaning or flushing purposes. The controller 63, in communication with the controls of the pretreatment tanks 40, directs the three-way actuated valve 44 to direct reject water to the flushing heads of the pretreatment tanks 40. The designated volume can be measured by monitoring a change in water level according to the level control valve 78. Additionally, or alternatively, the designated volume of water can be measured by monitoring a flow meter that is positioned in-line with the reject water that is being used. Any reject water in the water recovery tank 64 that it not used during the flushing operation can be saved for future flushing operations or for other purposes, such as a medical waste processing apparatus 42.

In one embodiment, the medical waste processing apparatus 42 is supported by the water recovery tank 64. In providing such support, the water recovery tank 64 directs reject water to the medical waste processing apparatus 42. The reject water is combined with a concentrated disinfectant to produce a disinfectant solution. Medical waste is treated with the disinfectant solution during or after processing. The used disinfectant solution is suitable for disposal through a municipal sewage system.

Depending upon the embodiment, the pretreatment tanks 40 and the medical waste processing apparatus 42 can each require that water be provided at a designated pressure. For example, some medical waste processing systems require that water be provided at a pressure of about seventy PSI. In an embodiment, the system pump 82 obtains reject water from the water recovery tank 64 and pressurizes the reject water to seventy PSI without using a downstream or supplemental pump. The water recovery system 36 can direct the resulting, pressurized reject water to one of the pretreatment tanks 40 for flushing or to the medical waste processing apparatus 42.

In another embodiment, the system pump 82 obtains reject water from the water recovery tank 64 and pressurizes the reject water to a first pressure (e.g. between thirty PSI and fifty PSI). This pressure is sufficient to move the reject water to a remote location where it contacts a downstream pump. In one embodiment, the downstream pump is the initial pump 45. In another embodiment, the downstream pump is the supplemental system pump 84. The downstream pump increases the pressure from the first pressure to a final pressure (e.g., seventy PSI). The final pressure is sufficient for purposes of flushing the pretreatment tanks 40 and for use by the medical waste processing apparatus 42.

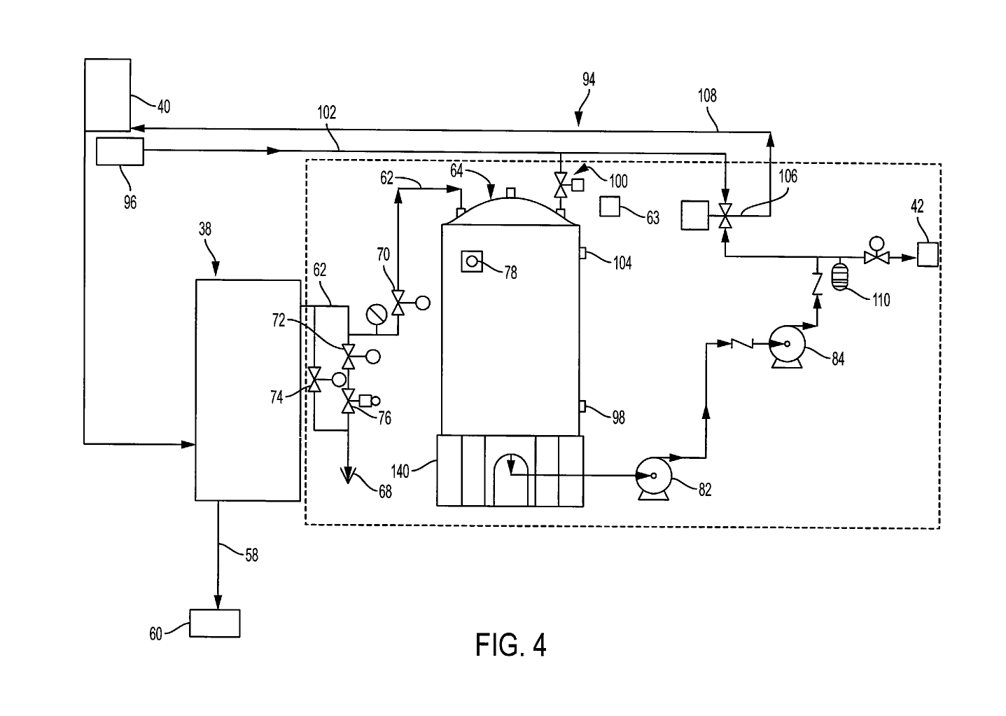

Referring to FIG. 4, in an embodiment, the water recovery system 94 includes and incorporates all of the elements, structure, functionality and logic of water recovery system 36. In this embodiment, the water recovery system 94 obtains supplemental feed water from a supplemental feed water source 96. In this embodiment, the supplemental feed water source 96 functions as a booster supply or pump. Water is filtered through the pretreatment tanks 40 (FIG. 2). The pretreated feed water is then supplied to the RO device 38. As described above, the RO device 38 outputs permeate or product water to the recipient unit 60, and the RO device 38 outputs retentate or reject water to the water recovery tank 64.

In an embodiment, the water recovery tank 64 includes a low-water sensor 98, which indicates whether the water recovery tank 64 has an inadequate water level. If the water level falls below a designated level, the low-water sensor 98 generates a low signal. The controller 63 receives such low signal, and, as a result, causes the opening of valve 100. This causes supplemental feed water to flow from the supplemental feed water source 96, through supplemental feed water line 102, to refill the water recovery tank 64. This prevents the water recovery tank 64 from running dry.

In some situations, the water recovery tank 64 may not have a sufficient volume of water to complete a flushing operation of pretreatment tanks 40 or to operate a medical waste processing apparatus 42. If the low-water sensor 98 indicates that water recovery tank 96 has an insufficient volume of water, but there is a current need for water (due to, for example, an ongoing flushing operation or medical waste process), the water recovery system 94 can satisfy such need using supplemental feed water from the supplemental feed water source 96.

In an embodiment, the controller 63 opens the low level fill valve 100 that connects the supplemental feed water source 96 directly to the water recovery tank 64 to supply supplemental feed water to the water recovery tank 64. This supplemental feeding may continue until the water level in the water recovery tank 64 reaches a high-water sensor 104. For example, the supplemental feed water may be continuously added until the low-water sensor 98 no longer detects a low volume of water and/or until the high-water sensor 104 detects a designated volume of water.

In an embodiment, the low-water sensor 98, under control of controller 63, actuates the valve 106. This actuation of valve 106 selectively connects the water recovery tank 64 to either the supplemental feed water source 96 via line 102 or to the pretreatment tanks 40 via line 108. If the water recovery system 94 enters the flush mode, but the water recovery tank 64 has an insufficient volume of water, the controller 63 can actuate valve 106 to bypass the recovery tank 64. In such event, the water recovery system 94 can use supplemental feed water from the supplemental feed water source 96 to flush the pretreatment tanks 40.

In an embodiment, the controller 63 can open the valve 100, or valve 100 can be manually opened, for purposes of servicing the water recovery tank 64. For example, by opening valve 100, supplemental feed water can be used to rinse, clean or flush the water recovery tank 64.

In an embodiment, the water recovery system 94 includes a bladder tank 110. In the illustrated example, bladder tank 110 is located downstream of the system pump 82 but upstream of the medical waste processing apparatus 42. The bladder tank 110 holds an amount of reject water to maintain a suitable level of pressure in the water recovery system 94 during the on-mode of the water recovery system 94 and when the water recovery system 94 is powered off The pressure maintained by the bladder tank 110 facilitates the controller's recognition of pressure conditions to properly control the startup of the water recovery system 94 and its pumps 82 and 84.

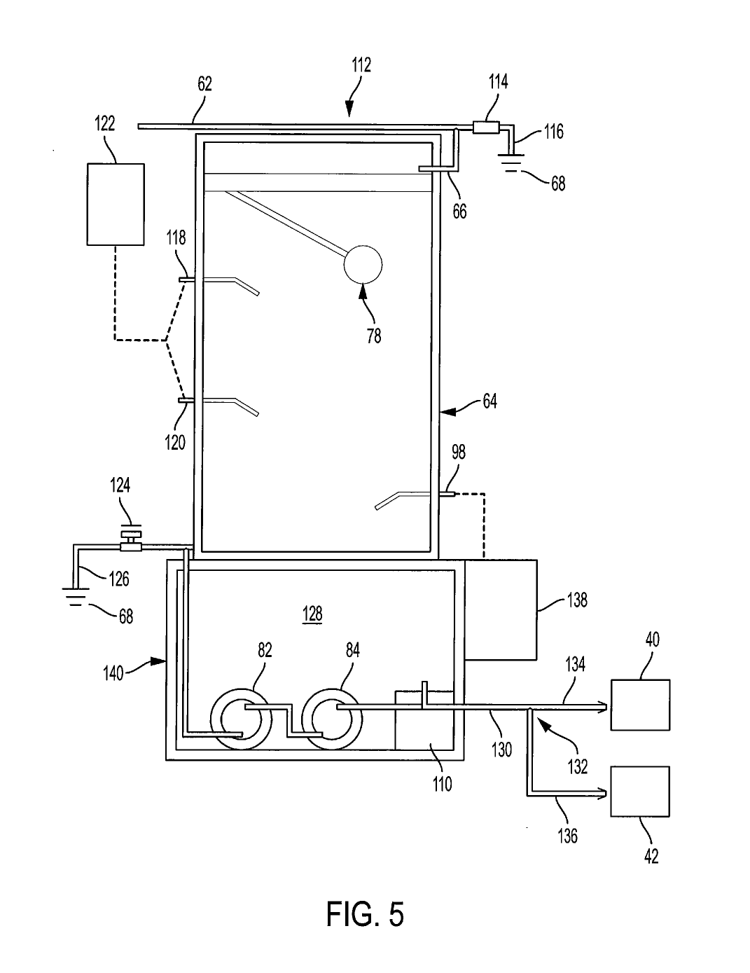

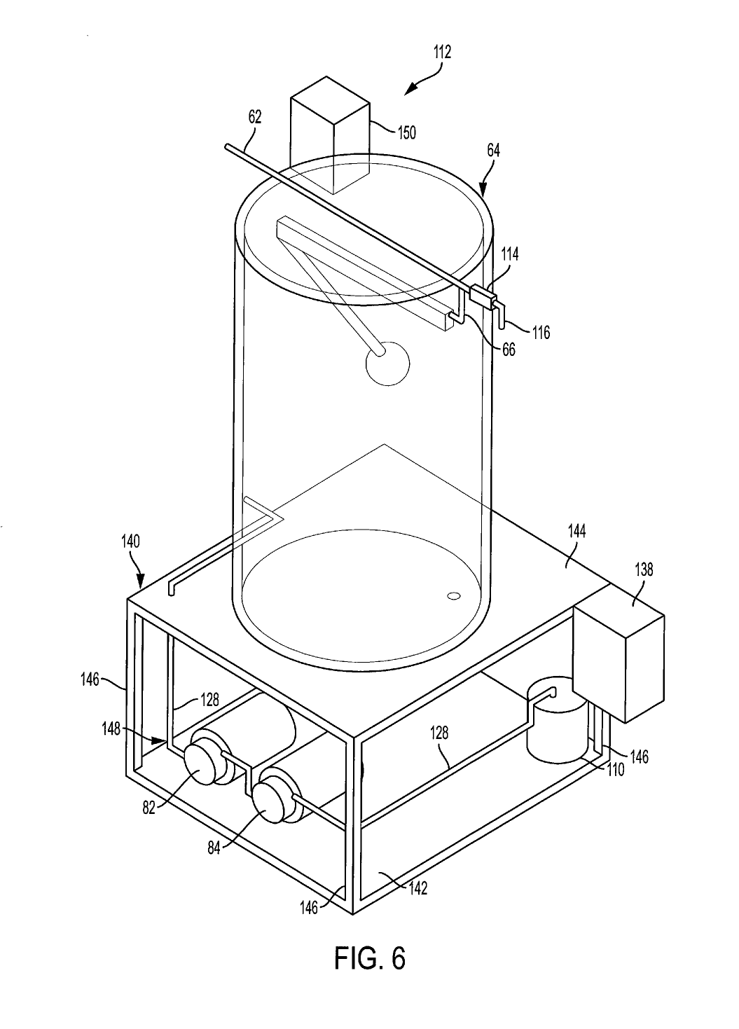

In an embodiment illustrated in FIGS. 5-6, the water recovery system 112 includes and incorporates all of the elements, structure, functionality and logic of water recovery system 94. In addition, water recovery system 112 includes: (a) a pressure regulator 114 fluidly coupled to water reject line 62 and operable to regulate the pressure of the reject water; (b) an upper drain conduit or upper drain line 116 fluidly coupled to the pressure regulator 114 and configured to route reject water to drain 68 depending upon pressure conditions; (c) a plurality of vertically spaced-apart level sensors 118 and 120 operable to: (i) monitor the variable water level in the water recovery tank 64; and (ii) transmit different water level signals to the level controller 122; (d) a ball valve 124 fluidly connected to a lower drain conduit or drain line 126; (e) an apparatus supply conduit or apparatus supply line 128 fluidly coupled to system pump 82, supplemental system pump 84 and bladder tank 110; (f) outflow port 130 fluidly connected to junction 132 to split the outflow path to: (i) a pretreatment conduit or pretreatment line 134 communicating with the pretreatment tanks 40 (FIG. 2); and (ii) a medical waste processing conduit or medical waste processing line 136 communicating with the medical waste processing apparatus 42; (g) a pump controller 138 operable to control the operation of the system pump 82 and supplemental system pump 84; and (h) a tank support structure 140 configured to support the water recovery tank 64.

Referring to FIG. 6, in an embodiment, the tank support structure 140 includes a boxlike configuration having: (a) a bottom panel or bottom platform 142; (b) a top panel or top platform 144; and (c) a plurality of legs 146 that connect the top platform 144 to the bottom platform 142. The tank support structure 140 defines an inner space or cavity 148 sized and configured house or otherwise hold the system pump 82, supplemental system pump 84 and bladder tank 110. In addition, the water recovery system 112 includes a main controller 150 operable to manage the overall operation of the water recovery system 112, coordinating communications with the level controller 122 and pump controller 138 and controllers of the other electromechanical components of the water recovery system 112, such as controllable valves and pressure regulators.

It should be appreciated that each of the water recovery systems 10, 36, 94 and 112 can include one or more controllers (including, but not limited to, controllers 63, 122, 138 and 150) to manage and control the electromechanical operation of each such system. In such embodiment, electrical circuitry and an electrical actuator are incorporated into one or more components of each such system, including, but not limited to, the valves, pressure regulators, flow regulators and pumps described above. In an embodiment, each such actuator incorporates a motor, electromagnetic driver or pneumatic driver. In an embodiment, the one or more controllers of each such system are operatively coupled to such actuators. This enables such controllers to automatically control the functionality and operation of such components. In another embodiment, some of such components are manually operable. In such embodiment, each such system is semi-automatically operable.

Depending upon the embodiment, each such controller can include a control circuit, processor, microprocessor, central processing unit (CPU) or other suitable form of circuitry configured to process data or otherwise execute machine-readable instructions. Each such controller can be operatively coupled to a plurality of input/output (I/O) devices (not shown) coupled to each such system.

In an embodiment, each such controller can include computer code, including, but not limited to, software code, one or more computer programs, or machine-readable instructions. In another embodiment, each such controller can include one or more application-specific integrated circuits (ASICs) or other hardware circuit components configured to control the logic and operation of each such system.

In an embodiment, each such controller includes a data processor or CPU and one or more data storage devices, including, but not limited to, a hard drive with a spinning magnetic disk, a Solid-State Drive (SSD), a floppy disk, an optical disk (including, but not limited to, a CD or DVD), a Random Access Memory (RAM) device, a Read-Only Memory (ROM) device (including, but not limited to, programmable read-only memory (PROM), electrically erasable programmable read-only memory (EPROM), electrically erasable programmable read-only memory (EEPROM)), a magnetic card, an optical card, a flash memory device (including, but not limited to, a USB key with non-volatile memory, any type of media suitable for storing electronic instructions or any other suitable type of computer-readable storage medium.

In an embodiment, each of the water recovery systems 10, 36, 94 and 112 provides a plurality of advantageous, technical effects. For example, each such system: (a) facilitates connectivity with a reject water line of a membrane-based filtration device, such as an RO device; (b) retrieves, saves and reserves reject water which would otherwise be wasted through a drain; (c) facilitates the recycling, reuse or otherwise use of the reject water for a variety of different utility purposes, including, but not limited, to flush-cleaning of pretreatment apparatuses and supplying water to medical waste processing apparatuses; (d) automatically managing the reject water level in the water recovery tank to avoid emptiness and overflow conditions; (f) automatically obtaining supplemental feed water if the water recovery tank has insufficient reject water to meet the demands of apparatuses, including, but not limited, to flush-cleaning of pretreatment apparatuses and supplying water to medical waste processing apparatuses; and (g) providing an integral assembly that supports the water supply tank and also houses the pumps and other components of the water recovery system to reduce space usage in facilities, simplify maintenance, protect the components and facilitate installation.

Additional embodiments include any one of the embodiments described above, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

The following is claimed:

1. A water recovery system comprising:
at least one tank;
at least one inflow port fluidly connected to the at least one tank, the at least one inflow port configured to be fluidly connected to a reject water conduit of a reverse osmosis device operable in accordance with a reverse osmosis filtration process, the reverse osmosis device configured to output:
(a) product water through a product water conduit of the reverse osmosis device; and
(b) reject water through the reject water conduit;
at least one pump;
at least one outflow port fluidly connected to the at least one tank, the at least one outflow port configured to fluidly connect the at least one tank to an apparatus other than the reverse osmosis device; and
at least one controller operable to control the pump to move the reject water from the at least one tank, through the at least one outflow port, to the apparatus,
wherein the apparatus is operable with the reject water, and
wherein the water recovery system facilitates usefulness of the reject water for one or more processes of the apparatus other than the reverse osmosis filtration process.

2. The water recovery system of claim 1, wherein the apparatus comprises a pretreatment apparatus fluidly connected to the reverse osmosis device.

3. The water recovery system of claim 2, wherein the pretreatment apparatus comprises at least one pretreatment tank selected from the group consisting of a solid screening tank comprising a solid screening media and a chemical treatment tank comprising an active carbon media.

4. The water recovery system of claim 3, wherein the at least one controller is operable in a flush mode to cause the reject water to flush the pretreatment apparatus.

5. The water recovery system of claim 4, wherein the at least one pump is configured to raise a pressure of the reject water to a pressure level required to flush the pretreatment apparatus.

6. The water recovery system of claim 1, wherein the apparatus comprises a medical waste processing apparatus.

7. The water recovery system of claim 6, wherein the at least one controller is operable in a supply mode to supply the reject water to the medical waste processing apparatus.

8. A water recovery system comprising:
at least one container;
at least one inflow port fluidly connected to the at least one container, the at least one inflow port configured to receive retentate from a retentate line of a membrane-based filtration device;
at least one outflow port configured to fluidly connect the at least one container to an apparatus other than the membrane-based filtration device, wherein the apparatus has a function other than membrane-based water filtration; and
at least one pump operable to move the retentate from the at least one container, through the outflow port, to the apparatus,
wherein the apparatus is operable with the retentate to perform the function.

9. The water recovery system of claim 8, wherein the apparatus comprises a water pretreatment apparatus fluidly connected to the membrane-based filtration device.

10. The water recovery system of claim 9, wherein the pretreatment apparatus comprises at least one pretreatment tank selected from the group consisting of a solid screening tank comprising a solid screening media and a chemical treatment tank comprising an active carbon media.

11. The water recovery system of claim 10, wherein the at least one pump is operable in a flush mode to cause the retentate to flush the pretreatment apparatus.

12. The water recovery system of claim 11, wherein the at least one pump is configured to raise a pressure of the retentate to a pressure level required to flush the pretreatment apparatus.

13. The water recovery system of claim 8, wherein:
the apparatus comprises a medical waste processing apparatus; and
the at least one controller is operable in a supply mode to supply the retentate to the medical waste processing apparatus.

14. The water recovery system of claim 13, wherein:
the membrane-based filtration device comprises a reverse osmosis device; and
the function of the apparatus is other than reverse osmosis filtration.

15. A method for utilizing retentate from a membrane-based filtration device, the method comprising:
(a) providing at least one container comprising at least one inflow port and at least one outflow port;
(b) fluidly connecting the at least one inflow port to a retentate conduit of a membrane-based filtration device;
(c) as a result of an operation of the membrane-based filtration device, collecting retentate from the membrane-based filtration device, wherein the retentate flows through the retentate conduit, through the at least one inflow port and into the at least one container; and
(d) pumping retentate from the at least one container, through the at least one outflow port and to an apparatus other than the membrane-based filtration device,
wherein the apparatus has a function other than reverse osmosis filtration; and
wherein the apparatus is operable with the retentate to perform the function.

16. The method of claim 15, wherein: (a) the apparatus comprises a water pretreatment apparatus fluidly connected to the membrane-based filtration device; and (b) the pretreatment apparatus comprises at least one pretreatment tank selected from the group consisting of a solid screening tank comprising a solid screening media and a chemical treatment tank comprising an active carbon media, the method comprising controlling the at least one pump so as to operate in a flush mode to cause the retentate to flush the pretreatment apparatus.

17. The method of claim 16, comprising controlling the at least one pump so as to raise a pressure of the retentate to a pressure level required to flush the pretreatment apparatus.

18. The method of claim 17, wherein the apparatus comprises a medical waste processing apparatus, the method comprising controlling the at least one pump so as to operate in a supply mode to supply the retentate to the medical waste processing apparatus.

19. The method of claim 15, comprising:
providing a level sensor operable to monitor a level of the retentate in the at least one container; and
opening a drain valve depending upon the monitored level of the retentate in the at least one container.

20. The method of claim 19, wherein the membrane-based filtration device comprises a reverse osmosis device, and the function of the apparatus is other than reverse osmosis filtration.
